(19) United States
(12) Patent Application Publication
(10) Pub. No.: US 2026/0086067 A1
(43) Pub. Date: Mar. 26, 2026

(54) System for the Simultaneous Monitoring of Constituents of an Electroplating Bath

(71) Applicant: Technic, Inc., Cranston, RI (US)

(72) Inventors: Kazimierz Wikiel, Wakefield, RI (US); Aleksander Jaworski, Franklin, MA (US); Tomasz Rapecki, Warwick, RI (US)

(73) Assignee: Technic, Inc., Cranston, RI (US)

(21) Appl. No.: 19/403,731

(22) Filed: Nov. 28, 2025

Related U.S. Application Data
(63) Continuation-in-part of application No. 18/225,416, filed on Jul. 24, 2023.
(60) Provisional application No. 63/416,465, filed on Oct. 14, 2022.

(51) Int. Cl. G01N 27/48; C25D 21/12; G01N 27/02; G01N 27/416

(52) U.S. Cl. CPC G01N 27/48; C25D 21/12; G01N 27/026; G01N 27/4161

(57) ABSTRACT

Methods of and apparatuses for monitoring a plating bath composition by using voltammetric consolidated designer waveforms. The designer AC waveforms are optimized and consolidated to maximize analytical output of the solitary measurement thus drastically reducing the total time required for a full analysis of a plating bath as compared to traditional analytical techniques. More specifically, the present invention relates to a novel concept of generating of a consolidated designer waveform from the preselected segments of designer AC waveforms. More particularly, the method of present invention relates to determination of segments of designer AC waveforms based on a novel chemometric parameter of Analysis of Variance relative F-ratio.

This application is a continuation-in-part under 37 C.F.R. § 1.53 (b) of U.S. patent application Ser. No. 18/225,416 filed on Jul. 24, 2023, that claims priority to and the benefit of U.S. Provisional Patent Application No. 63/416,465 filed August Oct. 14, 2022, the entire contents of each are incorporated by reference herein.

### BACKGROUND OF THE INVENTION

One of the key requirements for controlling an electrometallization process including, but not limited to electroplating, is the on-line monitoring and on-line control of the concentration of the metallic plating bath constituents. Proper concentration control is essential to ensure the void free and complete filling of the features including, but not limited to, vias and trenches often of complex morphology, optimum deposition rate, mechanical properties including, but not limited to, tensile strength, roughness and hardness, and grain structure of the plated metallic film depending on the needs of the customer. The concentrations of deliberately added bath constituents decrease during the electroplating process due to electrochemical and chemical consumption and/or drag-out. The knowledge of exact concentration levels of deliberately added bath constituents is necessary for maintaining the concentration of deliberately added bath constituents at the target level.

Another important issue is the buildup of additive breakdown products contaminating and affecting the electroplating process. Optimally, real-time monitoring of an electroplating process should be conducted and automatic adjustments to the concentration of the constituents of the electroplating bath should be made to the constituents.

A commonly employed technique in the field of electroplating uses on-line analyzers to monitor the concentration of organic additives in an electroplating bath commonly referred to as cyclic voltammetric stripping (CVS). The CVS method is based on a cyclic process of the plating and stripping of a metal from a rotating disc electrode. The adsorption of an additive on the surface of an electrode inhibits the rate of metal deposition. This decrease is quantified by measuring the anodic charge by integrating the stripping of a voltammetric peak. The decrease in deposited charge is related to the charge in the concentration of the organic additives. The CVS method integrates the multivariate voltammetric response of an anodic peak into a univariate output. A conventional voltammetric apparatus is a first-order instrument that produces an output in the form of a voltammogram, a vector (e.g., first-order tensor). The ultimate output of the CVS is univariate (e.g., zero-order tensor of the zero-order instrument) oxidation charge. The CVS does not benefit from the richness of analytical information contained in the voltammetric response of an anodic peak. The CVS method is focused solely on the anodic oxidation peak ignoring totally the cathodic portion of the multivariate voltammetric response. The multivariate voltammetric response contains analytical information relevant to electroplating process control. The CVS method does not teach how to extract analytical information from the multivariate voltammetric response of the cathodic portion.

High-Performance Liquid Chromatography (HPLC) is another quantitative analysis technique that is employed to monitor the concentrations of a plating bath's constituents, especially organic additives. HPLC is a technique in analytical chemistry used to separate, identify, and quantify each constituent in a mixture. HPLC relies on pumps to pass a pressurized liquid solvent containing the sample mixture through a column filled with a solid adsorbent material. The separation principle of HPLC is based on the distribution of the analyte (i.e., sample) between a mobile phase (i.e., eluent) and a stationary phase (i.e., packing material of the column). The pressurized liquid is typically a mixture of solvents (e.g., including, but not limited to, water, acetonitrile and/or methanol) and is referred to as a “mobile phase”. The active constituent of the column (i.e., stationary phase) is typically a granular material made of solid particles (e.g., silica, polymers, etc.), 2-50 μm in size. Depending on the chemical structure of the analyte, the molecules are adsorbed on the column stationary phase while passing through the column. The specific intermolecular interactions between the molecules of a sample and the packing material define their time “on-column,” resulting in different constituents of a sample being eluted at different times until the separation of the sample ingredients is achieved. A detection unit (e.g., including, but not limited to, ultraviolet (UV) light, fluorescence and refractive index detector) recognizes the analytes after leaving the column. The automatic on-line chromatographic equipment is characterized by high complexity resulting in prohibitively high expenditure cost and intensive maintenance requirements (e.g., including, but not limited to column conditioning, cleaning, and replacing) and having an adverse effect on reliability. Another fundamental drawback of HPLC for the application of monitoring of electroplating solutions is focusing on measurement of concentrations of separated organic constituents individually while missing the highly relevant impact that these constituents have while acting synergistically during the plating process.

Metara's In-Process Mass Spectrometry (IPMS™) (Metara, Inc., Sunnyvale, CA) is a unique metrology tool which provides sophisticated analytical capability and process diagnostics. The tool utilizes an electrospray-ionization time-off-light mass spectrometer (ESI-TOF/MS) for fully automated in-line monitoring of the copper plating process. The unique analytical capability of the IPMS™ enables the detection and quantitative measurement of anionic, cationic, and organic contamination as well as elemental species present as contamination in process solutions. Having an ability to measure breakdown products, an IPMS™ addresses the major weakness of the CVS that ignores breakdown products. The accumulated breakdown products impact the quality of the deposited film and need to be controlled. IPMS™ instruments provide an impressive amount of information related to the deliberately added chemical constituents and the amounts of chemical constituents formed as the breakdown products, during the electroplating process. However, as a weakness that is common to the prior art separation techniques, the IPMS™ instrument fails to connect data about singled-out chemical constituents with the overall performance of the electroplating process that is of the outmost relevance. By design, the bath constituents are intended to act in synergy whose outcome is often empirical and cannot be strictly modelled analytically. Controlling this synergy is driven by data about the plating solution in the solution's entirety. The analytical information obtained by using prior art separation techniques directed to the functional interdependence between bath constituents is lost. The cost of the IPMS™ instrumentation is prohibitively high, increased by the need for complex, robotic sample preparation necessary for the on-line mode.

The Real Time Analyzer (RTA) (Technic, Inc. Cranston, RI) provides an automatic, in situ, on-line monitoring of electrometallization baths. The RTA uses a unique combination of advanced electroanalysis (i.e., unlimited plethora of measurement techniques including direct current (DC) and alternating current (AC) voltammetry) with multivariate data compression and relevant information extraction chemometric techniques. As presented in FIG. 8, the claimed invention uses basic electroanalytical techniques to characterize simplified waveforms including, but not limited to, Linear Sweep Voltammetry (LSV), Cyclic Voltammetry (CV), Alternating Current Voltammetry (ACV), Staircase Voltammetry (SCV), Square Wave Voltammetry (SWV), Normal Pulse Voltammetry (NPV), Differential Pulse Voltammetry (DPV), Chronoamperometry (CA), Anodic Stripping Voltammetry (ASV), Cathodic Stripping Voltammetry (CSV) and Adsorptive Stripping Voltammetry (AdSV). The RTA provides information about concentration of electroplating bath constituents and about the comprehensive condition of the electroplating bath so that adjustments, such as controlled replenishment of the electroplating bath constituents, are made to the electroplating bath to ensure proper plating performance. Concentrations of the plating bath's constituents are measured by the RTA using only electroanalytical techniques. The voltammetric data obtained for the plating bath is quantitatively analyzed using for calibration chemometric techniques as discussed in U.S. Pat. No. 7,270,733 (WIKIEL et al., 2007).

The duration of the RTA analysis to provide information about concentration of all electroplating bath constituents takes less than thirty (30) minutes. The RTA analyzes samples without any pretreatment and the unaltered sample is returned, post analysis, back into the plating tank. The RTA provides early fault detection, such as plating bath contamination due to accumulation of degradation products or the presence of foreign contaminants, and bath “health” diagnosis as discussed in U.S. Pat. No. 7,124,120 (WIKIEL et al., 2006), the entire contents of which is incorporated herein. The RTA utilizes electrochemical techniques for the analysis of an electroplating bath solution without pre-treating the analyzed sample and as such, the RTA comprehensively characterizes the electroplating process by mimicking this process in experimental conditions that are almost identical to the condition of the electroplating tank. Any disturbances affecting the plating performance are manifested in RTA voltammetric responses. Deviations from the proper plating pattern are detected to assure consistency of the electroplating process. The process controlled by RTA is enhanced by adding a new capability focused on pattern recognition that goes beyond simple constituent concentration determination.

The analysis of electroplating baths while in use poses immense challenges. The solutions employed in electrometallization are a very complex media whose constituents, by design, are selected and optimized to interact with each other synergistically during the electroplating process in order to achieve the desired structure and physical properties of the deposited metal. The electrobath constituents are fundamentally different in their physical and chemical properties and in their concentration levels in the plating solution. The electroplating bath solution is a dynamic medium. The changes to the concentrations of the plating bath constituents occur at various rates during the idle periods and the electroplating process is what causes complications in process control based on monitoring of concentrations of plating bath constituents. Drag-out in which electroplating solution is carried out of the electroplating bath as the plated objects are removed is problematic. Compositional changes, such as the degradation of organic additives that depend upon number of objects being plated and the parameters that are employed in different plating recipes, are also problems affecting the quality of the desired plating. The buildup of by-products from the organic additives in the plating tank over time, also adversely impacting the plating performance.

The electroplating processes of Copper Damascene (CD) and Through Silicon Via (TSV) are commonly used in the metallization of silicon wafers in semiconductor manufacturing. Accurate and prompt monitoring of concentration of all bath constituents in the CD and TSV processes is essential to minimize costs and to satisfy process specifications for high-yield manufacturing of integrated circuits. Well-maintained electroplating processes minimize defects in products as well as minimizing production interruptions. The effective defect-free, bottom-up filling of features, such as trenches and vias, by copper electrodeposition, relies on additive systems including, but not limited to, an accelerator, a suppressor and a leveler that promote bottom-up filling, macro and minimal overplating. Suppressors that inhibit electrodeposition are high molecular weight polyether or polyoxyethylene alkyl ether polymers. Suppressors adsorb (i.e., in the synergistic combination with chloride ions) rapidly, but weakly, at the surface of the object being electroplated with copper. The suppressor-chloride molecular association is subsequently deactivated in competition with accelerators.

The accelerators, such as bis(3-sulfopropyl) disulfide (SPS) (Raschig, Espenhain, DE) or its reduced monomer 3-mercaptopropylsulfonate (MPS) (Sigma Aldrich Chemicals, St. Louis, MO), competitively replace the suppressor-chloride molecular association adsorbed at the electroplated surface. The adsorbed accelerator facilitates the accelerated growth of the copper deposit at the bottom of the feature, such as trenches and vias. Levelers, such as polyethyleneimines (PEI) (Sigma Aldrich Chemicals, St. Louis, MO) or polyvinylpyrrolidones (PVP) (Sigma Aldrich Chemicals, St. Louis, MO) are inhibitors and surface leveling agents that prohibit excessive copper growth of copper deposit above the features, such as trenches and vias.

For on-line monitoring of plating bath constituents used in electroplating processes such as copper damascene and Through Silicon Via, there is a demand for a prompt analytical technique for measuring concentration of plating bath constituents directly in the plating solution without any sample modification or pretreatment processes including, but not limited to, dilution, chemical addition, and masking.

The method to analyze the constituents of an electroplating bath in a single measurement is mass spectrometry (MS). MS produces an impressive amount of information related to the chemical species present in an electroplating bath, including the amount of such constituent in the bath, MS requires significant data interpretation making MS impractical and irrelevant for monitoring electroplating baths during an electroplating process. Additionally, MS as a separation method shares the same fundamental weakness as chromatographic techniques of being incapable of identifying and investigating the synergistic interactions between the plating bath constituents that is of imperative relevance in defining and monitoring the plating performance.

For electroanalytical methods, the fundamental differences in physical and chemical properties of the electroplating bath constituents require using highly individualized, separate approaches for each bath constituents. This individualization requirement involves not only using various parameters of electroanalytical signals for each of the bath constituents, but also individual sample preparation for each constituent (FREITAG W O et al., (1983), Plating Surf Fin, 70 (10): 55-66). Although several bath constituents are analyzed with CVS, each constituent of the electroplating bath is monitored using a different procedure requiring separate hardware and chemicals for sample preparation and frequent standardization. Even if these routines and procedures share the same rotating disk electrode (RDE)-based electroanalytical cell, such a consolidation becomes a bottleneck adversely affecting the analysis of the constituents of the electroplating bath, thus increasing the time required for a complete analysis of the bath. Additionally, a requirement of sample preparation (i.e., aiming to suppress the effect of all constituents) with the exception of a constituent to be analyzed, limits the amount of analytical information related to the synergistic interaction between bath constituents that is of critical relevance for the monitoring of the electroplating bath to quantify the electrometallization process performance. Conventional electroanalytical techniques, designed for the zero- and first-order instruments (source), require using strict and limited parameters to define an electroanalytical waveform that limits the analytical information that could be obtained from such qualitatively and quantitatively diverse media, such as a standard electroplating solution.

The parameter-based limitations of conventional electroanalytical techniques adversely affect the general progress of fundamental mechanistic studies such as the identification of reversibility or quasi-reversibility and contributions from uncompensated resistance and background capacitance. The term “Designer AC Waveform” was introduced by Tan et. al. (TAN Y et al. (2009), J Electroanal Chem, 634 (1): 11-21). Tan et al. focused mainly on mechanistic studies analyzing comparatively experimental and simulated data, concluding that use of a complex multi-frequency AC waveform enables the identification of reversibility or quasi-reversibility and contributions from uncompensated resistance and background capacitance. The major emphasis of Tan et al. was the parametrization of complex reactions, either by heuristically or by Bayesian and machine learning frameworks. Other attempts to “modify” conventional DC and AC electroanalytical waveforms focused on improving method for determining physicochemical parameters, rather than obtaining practical analytical advantages in form of the concentration values. The prior art requires that the analyte to be well defined to be parametrized qualitatively and quantitatively. Analyte stabilization requirements are imperative for mechanistic studies. Analyte stabilization requirements counter the process control conditions especially of such dynamic quantitatively (i.e., depletion of concentration of deliberately added constituents) and qualitatively (i.e., accumulation of a plethora of breakdown products and foreign contaminants) in complex media, such as electroplating solutions.

The demand for a prompt analytical technique capable of measuring all deliberately added bath constituents during an electrometallization process is only met by electroanalytical instrumentation. To meet the demand for a prompt analytical technique capable of measuring all deliberately added bath constituents, the electroanalytical instrumentation must be capable of analyzing the electroplating solution without any pretreatment. To meet the demand for a prompt analytical technique capable of measuring all deliberately added bath constituents, the analyses electroanalytical instrumentation must be capable of analyzing all constituents of the electroplating solution with a single sensor.

### BRIEF SUMMARY OF THE INVENTION

The present invention is directed to a device and methods to monitor the constituents of any electrolyte. More specifically, the present invention relates to methods for monitoring the constituents of a plating bath based on novel second-order voltammetric consolidated designer waveforms developed with Analysis of Variance of voltammetric data obtained for the monitored bath. More particularly, the device and methods of the present invention relate to the development of voltammetric consolidated designer waveforms by implementing an Analysis of Variance. More specifically, the device and methods of the present invention relate to the development of voltammetric consolidated designer waveforms by utilizing an Analysis of Variance relative F-ratio. More particularly, the method of the present invention relates to development of voltammetric consolidated designer waveforms by utilizing relative F-ratio analysis for determination of segments of designer AC waveforms to be consolidated to form a consolidated designer waveform.

### BRIEF DESCRIPTION OF THE SEVERAL VIEWS OF THE DRAWINGS

FIG. 1 is a schematic rendering of the apparatus designed to monitor an electroplating bath composition.

FIG. 2 is a flow chart of the steps undertaken by the apparatus designed to monitor an electroplating bath composition.

FIG. 3 is a graphical representation of the AC Multifrequency Component of a Designer Waveform generated by the apparatus designed to monitor an electroplating bath composition.

FIG. 4 is a graphical representation of the DC Component of a Consolidated Designer Waveform generated by the apparatus designed to monitor an electroplating bath composition.

FIG. 5 are a series of 3D plots resulting from the relative F-ratio analysis performed by the apparatus designed to monitor an electroplating bath composition.

FIG. 6 are a series of contour plots resulting from the relative F-ratio analysis performed by the apparatus designed to monitor an electroplating bath composition.

FIG. 7 is a graph of combined contour plots resulting from the relative F-ratio analysis performed by the apparatus designed to monitor an electroplating bath composition.

FIG. 8 is a diagram of the basic electroanalytical techniques for simplified waveforms utilized by the claimed device.

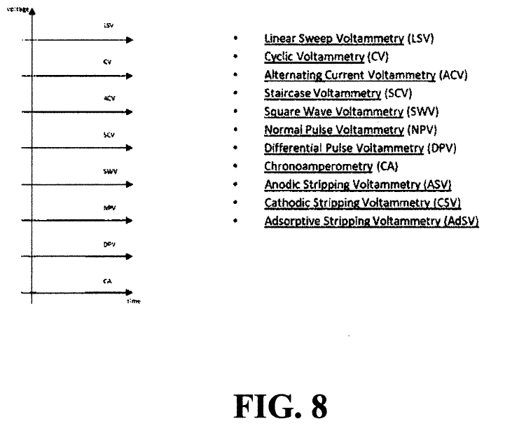

### DETAILED DESCRIPTION OF THE INVENTION

Consolidated Designer Waveform (CDW), the term “consolidated designer waveform (CDW), refers to a waveform obtained by a consolidation of preselected segments of Designer AC Waveform. The CDW is generated and its response recorded by a Comprehensive Electrochemical Controller. The segments of the consolidated designer waveform are the sum of the AC and DC components. In the preferred embodiment, the segments are diagnostic (i.e., able to interact with) to all of the constituents of a metal plating bath, preferably an electroplating, bath.

Comprehensive Electrochemical Controller, the term “comprehensive electrochemical controller” refers to electroanalytical instrumentation consisting of a potentiostat, multi-frequency waveform generator and data acquisition (DAQ) module capable of executing potentiodynamic multi-frequency waveforms while controlling the electrochemical cell. The comprehensive electrochemical controller has the capability of conducting Fast Fourier Transformation (FFT) obtained analytical data. Comprehensive electroanalytical controllers are commonly used in electroanalytical chemistry, as reviewed by Bandarenka (BANDARENKA AS, (2013), Analyst, 138:5540-54). The hardware and DAQ module of the comprehensive electrochemical controller was described in detail in prior studies upon introduction of the concept of Designer AC Waveform by Tan et al. (TAN Y et al., (2009), J Electroanal Chem, 634 (1): 11-21) or in dynamic Electrochemical Impedance Spectroscopy studies by Sacci et al. (SACCI R L et al., Electochim Acta, 131 (10): 13-9 and SACCI R L et al., ECS Trans, 19 (20): 31-42) and Ragoisha et al. (RAGOISHA GA and BONDARENKO AS, (2003), Electroanal, 27 (4): 855-63 and RAGOISHA GA and BONDARENKO AS, (2005), Electrochim Acta, 35 (1): 1553-63).

Designer AC Waveform, the term “designer AC waveform” refers to a waveform obtained by superimposition of several periodic potential waveforms, each of different frequency, on a single DC potential ramp. Designer AC waveform consists of controlled variables generated by a Comprehensive Electrochemical Controller. Depending on configuration of Comprehensive Electrochemical Controller, the Designer AC Waveform can generate a response in the form of a dynamic Electrochemical Impedance Spectrum, a Fourier Transference Alternating Current (FT-AC) Voltammogram or a Multi-frequency Voltammogram.

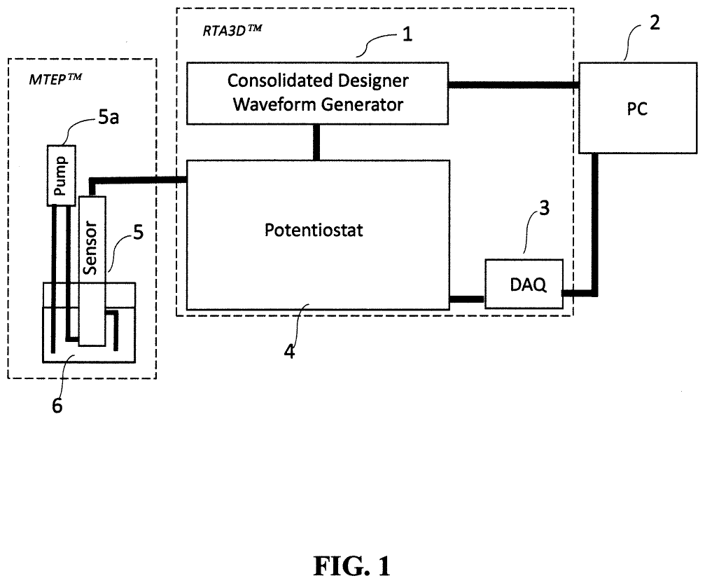

Electrochemical analyzers are the most common metrology tools used to monitor electroplating process as analyzers measure physicochemical processes of an electrodeposition procedure. The Technic RTA metrology tool (Technic, Inc., Cranston, RI) analyzes plating solution samples without the need for any pretreatment of the constituents of an electroplating bath utilizing the actual electrodeposition process. Traditional electroanalytical techniques use zero-order instruments and first-order instruments that deliver the analytical output in the form of a scalar or a vector. Recently, Technic, Inc. (Cranston, RI) developed and commercialized Real Time Analyzer 3D (RTA3D™) a unique electrochemical second-order analyzer purposefully designed for a plating process control. FIG. 1 illustrates a block diagram of an analyzer with a closed loop bath circulation in which the plating tank 6 solution samples are analyzed by an electrochemical sensor 5 without requiring any sample pretreatment in which the sample is returned in an unaltered state back to the plating tank. The sensor 5 is a compact flow-through electrochemical cell (i.e., the electrode compartment of a Multi-Task Electrochemical Probe™) (MTEP™ 5) (Technic, Inc., Cranston, RI). The electrode compartment of MTEP™ 5 is a conventional 3-electrode cell consisting of a Pt-wire working electrode, a Pt-foil counter electrode, and a freshly electroplated metal for instance Cu for CD and TSV processes from an analyzed plating solution sample deposited on the Pt wire as a reference electrode. The electrode system is built into the polytetrafluoroethylene (PTFE) housing. The volume of the inner compartment containing the analyzed plating solution is about 20 mL. In the preferred embodiment, the electroplating bath comprises one or more of the metals selected from the group consisting of Cu, Sn, Pb, Ni, Zn, Ag, Au, Cd, Co, Cr, Rh, Ru, Pd, In, Bi, and their alloys.

The MTEP™ 5 can be easily installed within 5 to 10 minutes without interfering with ongoing production (and integrated with the plating tool if needed). The short installation time is imperative for the continuity of semiconductor manufacturing characterized by high monetary value. Equipment installation causes disruption in the continuous production resulting in monetary losses. The objection of the instant invention is to minimize disruptions caused by equipment installation.

Circulation of the analyzed solution (i.e., in-situ plating bath solution without any sample pretreatment) inside the MTEP™ 5 is achieved by utilizing a software-controlled diaphragm pump 5a. It is of fundamental importance that the MTEP™ 5 analyzes the plating bath constituents using electroanalysis. The MTEP™ 5 is connected with cables to the RTA3D™ consisting of the electronic modules such as potentiostat 4, Designer Waveform Generator 1, and DAQ module 3. The process control (PC) 2 regulates the electronic modules of the Comprehensive Electrochemical Analyzer and the diaphragm pump 5a (Technic, Inc., Cranston, RI). The PC 2 controls electronic modules of the Comprehensive Electrochemical Analyzer using custom-designed software (Technic, Inc., Cranston, RI). The operational principles of functionality of the custom-designed software (Technic, Inc., Cranston, RI) are not unique but rather are common to those used for controlling of other comprehensive electrochemical analyzers as shown in prior studies upon introduction of the concept of Designer AC Waveform by Tan et al. (TAN Y et al., (2009), J Electroanal Chem, 634 (1): 11-21) or in dynamic Electrochemical Impedance Spectroscopy studies by Sacci et al. (SACCI R L et al., Electochim Acta, 131 (10): 13-9 and SACCI R L et al., ECS Trans, 19 (20): 31-42) and Ragoisha et al. (RAGOISHA GA and BONDARENKO AS, (2003), Electroanal, 27 (4): 855-63 and RAGOISHA GA and BONDARENKO AS, (2005), Electrochim Acta, 35 (1): 1553-63). The digital parameters of the voltammetric waveform are entered to the PC 2. The PC2 transfers the parameters of the voltammetric waveform to the Consolidated Designer Waveform Generator 1. The Consolidated Designer Waveform is applied to the sensor 5 via the potentiostat 4 module. The current response to the voltammetric waveform perturbation is recorded by the DAQ 3 module and read and processed numerically by the PC 2.

The RTA3D™ is a multi-order instrument. The RTA3D™ executes first-order-instrument conventional voltammetric techniques. Additionally, the RTA3D™ is designed as a second-order instrument capable of superimposing a periodic potential perturbation resulting from numerous sinewaves over any custom-designed DC potential including those of conventional voltammetric techniques.

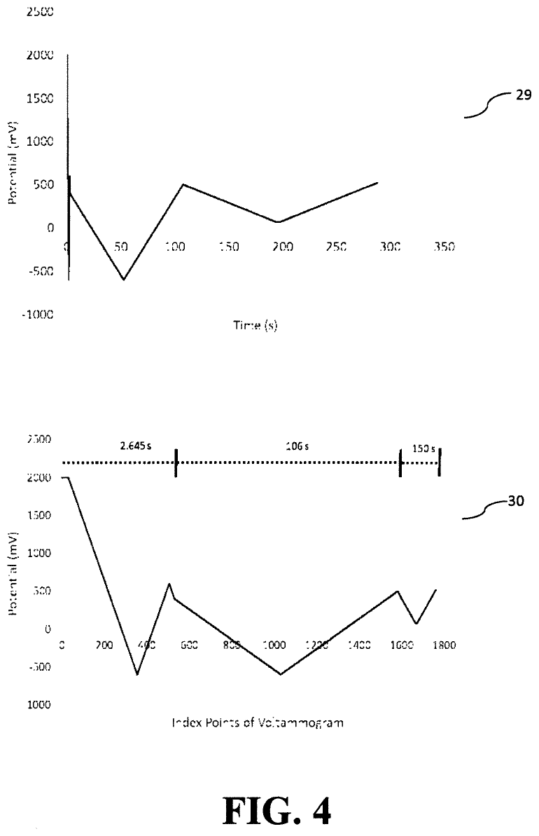

The Comprehensive Electrochemical Controller (Technic, Inc., Cranston, RI) is highly flexible electroanalytical instrument is a highly flexible electroanalytical instrument that directs the MTEP™ 5 via its subcomponent, the potentiostat 4, to generate any received from the Consolidated Designer Waveform Generator 1 and collecting an output signal from the DAQ module 3 to be recorded on the PC 2. The computer-controlled 2 versatile Consolidated Designer Waveform Generator's 1 electroanalytical system is capable of superimposing a periodic potential perturbation resulting from numerous sinewaves over any custom-designed DC potential including those of conventional DC voltammetric techniques for example a DC Cyclic Voltammetry, DC Linear Scan Voltammetry and Chronoamperometry. These conventional DC voltammetric techniques are the output of first order instruments and are used to characterize the DC component of segment by measuring, among other characteristics of the wave, the frequency, amplitude and scan rate of the component. As shown in FIG. 4, the potential of the DC Component of a Consolidated Designer Waveform generated by the apparatus designed to monitor an electroplating bath composition, ranges from +3 V to −3V, preferably ranging from +2V to −2V The DC component of the consolidated designer waveform exhibits scan rates ranging from 5 mV/s to 20,000 mV/s, preferably from 10 mV/s to 5,000 m V/s.

After collection by the DAQ 3 module, the experimental data is interrogated by the signal processing software installed in the PC 2 that utilizes the Fast Fourier Transformation (FFT). The FFT algorithm initially converts the time-domain data into a frequency domain. The data is separated based on the multiple fundamental frequencies and the fundamental frequencies harmonics. Next, an inverse FFT algorithm is applied to each selected constituent to generate a DC component, multiple fundamental, and their higher-harmonic time-domain signals. This AC voltammetric analyzer executes multi-frequency and variable amplitude designer waveforms. The AC voltametric analyzer is a second-order instrument designed to generate multi-way data with a common time domain without compromising the duration of the electroplating process as do first-order instruments. The AC voltametric analyzer is designed to produce any form of a DC potential waveform (also those being a combination of conventional DC voltammetric techniques) with superimposed multiple potential perturbations.

The AC voltammetric analyzer is designed as an empirical platform for introducing multi-frequency designer waveforms consisting of consolidated various DC ramps. The large number of electroanalytical parameters, such as initial potential of DC potential ramp, vertex potential of DC potential ramp, end potential of DC potential ramp, scan rate, several frequencies of AC potential perturbations and several amplitudes of AC potential perturbations, is integrated into a single waveform on a second-order AC voltammetric analyzer. The resultant multivariable electroanalytical output contains diagnostic portions of voltammogram for each of the bath constituents. Accordingly, a single electroanalytical measurement determines the concentrations of the constituents of an electroplating bath even when the constituents of the bath are present in the bath in different concentrations and the constituents in the bath are chemically distinct. The consolidation of relevant analytical information about all bath constituents into a single multivariate voltammetric output results in a shortening of the total time of analysis.

### Method Development

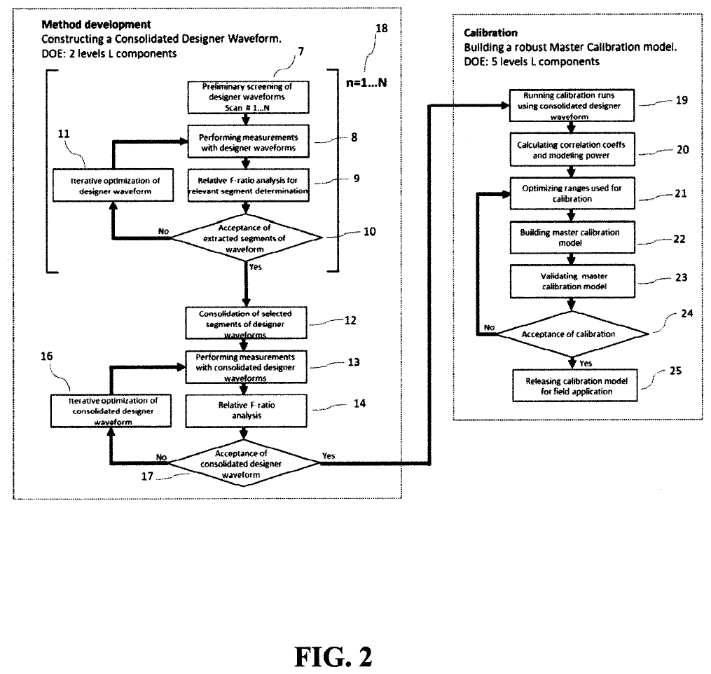

The novel method for monitoring an electroplating bath during an electrodeposition process comprises two distinct steps: construct a Consolidated Designer Waveform (CDW) (i.e., a consolidated multi-frequency voltametric) followed by calibration to create a robust master calibration analytical model. See FIG. 2 The first distinct step of the method relates to a novel concept of generating of a consolidated designer waveform from the preselected segments of designer AC waveforms. More particularly, the method of present invention relates to determination of segments of designer AC waveforms based on a novel chemometric parameter of Analysis of Variance relative F-ratio. Preferably, the selected segments of the designer waveforms have a relative F-ratio for each bath constituent higher than 0.8, preferably higher than 0.9. The other step of the method, the calibration utilizing chemometrics, is already an established routine and was outlined in U.S. Pat. No. 7,270,733 (WIKIEL et al, 2007).

To establish proof of concept that the claimed device and method discussed herein is effective, an actual plating bath used for Cu damascene processes in the semiconductor manufacturing was used. Applicant avers that the method to monitor an electroplating bath during a plating process as discussed herein is universal and is not limited to only Cu damascene processes used during semiconductor manufacturing.

Regarding the flowchart of FIG. 2, the concentration matrix of Analysis of Variance is based on the two-level J-constituent fractional factorial. The number of constituents, L, corresponds to the number of constituents of the tested plating solution of copper, acid, chloride, an accelerator, a suppressor and a leveler. Two level factorial designs are very effective for screening. Each of the constituents of the tested plating solution is present at the concentration level corresponding to the constituents low or high concentration limit of the future calibration, denoted as −1 and 1, respectively. The 2-level 6-constituent factorial consists of 2⁶=64 solution combinations. Preparation of a great number of samples is impractical. As such, the concentration matrix is reduced eight times by introducing fractional factorial that retains the orthogonality among the Z factors. The design of a two-level 6-constituent fractional factorial of 8 concentration combinations is described as

$${2}_{III}^{6 - 3}$$

(GEP BOX et al., (eds), Chapter 10: “Factorial Designs and Two Levels,” Statistics for Experimenters: An Introduction to Design, Data Analysis, and Model Building, 1978, John Wiley & Sons (publ), New York, NY, pp. 306-51), where the subscript III denotes the resolution of the design. The superscript-3 indicates that one-eighth (⅛) of the full factorial of 64 rows is taken as (⅛×64=2⁻³×2⁶=2⁶×2⁻³=2⁶⁻³). Out of eight combinations of triples of design for

$${2}_{III}^{6 - 3} :$$

±4=12, ±5=13, and ±6=23, the triple of all positive signs was chosen, resulting in a concentration matrix depicted in Table 1. Consequently, the generating relations are G=124, G=135, and G=236, while generators 124, 135, and 236 produce a complete defining relations G=124=135=236=456=1256=1346=2345 (GEP BOX et al., (eds), Chapter 10: “Factorial Designs and Two Levels,” Statistics for Experimenters: An Introduction to Design, Data Analysis, and Model Building, 1978, John Wiley & Sons (publ), New York, NY, pp. 306-51). The length of the shortest word in the defining relation determines the resolution R=III of the design.

TABLE 1
Concentration matrix for scan development calculated
based on fractional factorial design.

| | Copper | Acid | Chloride | Accelerator | Suppressor | Leveler |
|---|---|---|---|---|---|---|
| | constituent | constituent | constituent | constituent | constituent | constituent |
| Solution # | l = 1 | l = 2 | l = 3 | l = 4 | l = 5 | l = 6 |
| D1 | −1 | −1 | −1 | 1 | 1 | 1 |
| D2 | 1 | −1 | −1 | −1 | −1 | 1 |
| D3 | −1 | 1 | −1 | −1 | 1 | −1 |
| D4 | 1 | 1 | −1 | 1 | −1 | −1 |
| D5 | −1 | −1 | 1 | 1 | −1 | −1 |
| D6 | 1 | −1 | 1 | −1 | 1 | −1 |
| D7 | −1 | 1 | 1 | −1 | −1 | 1 |
| D8 | 1 | 1 | 1 | 1 | 1 | 1 |

As factorials provide an approximation only within the experimental range, the selection of low and high concentration limits, uniformly normalized as −1 and 1 respectively, was carefully selected. The target concentration is included in the concentration range. Also, the experimental range for method development is suggested to be greater than the process control range. The method development range determines the range for the subsequent calibration training matrix. The calibration needs to cover a wider range than the process range to provide accurate concentration predictions, not only for the sample of the target composition, but also for the concentrations of the plating tank solution samples approaching the process control limits. Depending on a specific constituent and the process control requirement, such as the process control range of the specific plating process, the typical experimental range is +20-50% of the target composition.

The pure fractional factorial does not provide replicate information, such as analytical measurements including, but not limited to the execution of voltametric scans for sample solution considered a weakness of this rigorous approach (R G BRERETON (ed), (2003), Chemometrics: Data Analysis for the Laboratory and Chemical Plant, John Wiley & Sons, Ltd. Chichester, UK). The omission of repetitions is a compromise made when optimizing the experiment design, however, the Inventors of the method and apparatus described herein, incorporated repetitions with some constraints, during the waveform development process by exploiting the unique advantages of the RTA3D™ (Technic, Inc., Cranston, RI) and by doing so, the repetitions did not impose an experimental burden. As the selected RTA3D™ did not alter the sample, it was discovered that the same solution could be analyzed several times in a row providing a much-needed indication of the repeatability of the waveform being developed. The duration of the experiment was extended by the repetition by several minutes. As only the waveform of interest was repeated, the electrode pretreatment scans remained the same for a single or multiple diagnostic waveforms, while data collection, such as measurement, was automatically generated without involving the operator. The poor repeatability of a waveform disqualified that waveform at the initial stage of development process. To assess the reproducibility of the waveform being developed, each waveform was executed three times for each of the eight solution compositions provided in Table 1. Consequently, the total number of samples tested was I=3×8=24. The total number of factors L=6 corresponded to the number of the constituents in the tested plating solution: copper, acid, chloride, an accelerator, a suppressor and a leveler whose concentrations of the constituents were varied. The concentration matrix is defined as Y^{(I,L)}. For the tested solution in particular the concentration matrix was Y^{(24,6)}.

Regarding FIG. 2, the preliminary screening 7 step (the first step of the iterative process of waveform parameter optimization) comprises the selection of an initial set of multi-frequency voltammetric waveforms. Each of the N multi-frequency voltammetric waveforms produce a current response predominantly determined by the varying concentration of any of the L=6 constituents of the plating solution. The N multi-frequency voltammetric waveforms are negligibly dependent on the varying concentrations of other constituents in the tested plating solution. As a single multi-frequency waveform may exhibit the diagnostic characteristics for more than one of L=6 constituents, the number N of preliminary screening waveforms may be lower than L.

Having selected an initial set of N multifrequency voltammetric waveforms, the voltammetric experiments are carried out in step 8 of FIG. 2 for the eight solutions of the compositions listed in Table 1, each of the composition solutions were analyzed in triplicate.

### Introductory Derivation of Anova Relative F-Ratio

The data collection step 8 is followed by the constituent analysis step 9. The constituent analysis is performed individually for each of the N waveforms 18 of multi-frequency AC voltammetric data. In the following detailed description of method discussed herein, the waveform index n=1, . . . , N is intentionally omitted for brevity.

The numerical voltammetric data corresponding to the investigated waveform (one of N) was arranged in a three-way array X^{(I,J,K)}, wherein J and K denote the number of index points of the voltammogram and the number of fundamental frequencies of AC sinusoidal potential perturbations superimposed on the DC ramp. The preliminary assessment of the analytical usefulness of voltammetric data is based on determination of a correlation between the AC current response for each j-th index point of the voltammogram and the k-th sinusoidal perturbation frequency for each of the l-th constituents. The squared correlation coefficient is calculated using the I elements of the column vector of three-way array of voltammetric data

$${x}_{jk}^{( I )} ⊂ {X}^{( I , J , K )}$$

and the I elements of the column vector of the concentration represented by

$${y}_{l}^{( I )} ⊂ {Y}^{( I , L )} .$$

The I, J, k, l variables are the indexes of I, J, K, and L, respectively. The squared correlation coefficient is described by the following formula:

$${R}_{jkl}^{2} = \frac{{[ {\sum }_{i = 1}^{I} {x}_{ijk} {y}_{il} - {\sum }_{i = 1}^{I} {x}_{ijk} {\sum }_{i = 1}^{I} {y}_{il} / I ]}^{2}}{{\sum }_{i = 1}^{I} {x}_{ijk}^{2} - {( {\sum }_{i = 1}^{I} {x}_{ijk} )}^{2} / I ] [ {\sum }_{i = 1}^{I} {y}_{il}^{2} - {( {\sum }_{i = 1}^{I} {y}_{il} )}^{2} / I ]} \qquad ( 1 )$$

where

$${x}_{ijk} ∈ {x}_{jk}^{( I )} and {y}_{il} ∈ {y}_{l}^{( I )} .$$

The squared correlation coefficient values are arranged in a three-way array with the number of rows, columns and slabs being J, K, and L, respectively:

$${R}_{jkl}^{2} ∈ {R}^{2 ( J , K , L )} .$$

Apart from bivariate determination of the squared correlation coefficient of the three-way array, another key parameter used to assess the analytical utility of the investigated multifrequency AC voltammetric waveform, is the relative F-ratio. The relative F-ratio is calculated by the analysis of the variance for each of the j^{th} of J index points of the voltammogram, wherein each of the k^{th} of K sinusoidal perturbation frequencies and each of the l^{th} of L constituents of the electroplating solution.

The F ratio calculation starts with determination of the grand average of the AC voltammetric current response for each index point of the voltammogram and each observed perturbation frequency based on the following expression:

$${\overline{x}}_{jk} = {\sum }_{i = 1}^{I} {x}_{ijk} / I \qquad ( 2 )$$

$$where {\overline{x}}_{jk} ∈ {\overline{X}}^{( J , K )} .$$

For each l^{th} constituent of the electroplating solution, the three-way array of the voltammetric data X^{(I,J,K)} is split into two three-way subarrays of the same dimensions (I/2, J, K). One subarray denoted by the subscript “−1”, corresponds to voltammetric data recorded for a lower concentration level, −1, (Table 1) of the l-th constituent:

$${X}_{- 1}^{l , ( \frac{I}{2} , J , K )} .$$

The other subarray, denoted by a subscript “1”, contains voltammetric data obtained for the upper concentration level, 1, of, the l^{th} constituent of electroplating solution: X1 l,(I 2, J, K). Using the data arranged into subarrays based on the concentration of l^{th} constituent, the response average is calculated for both the lower and upper concentration levels individually for each j^{th} index point of the AC voltammogram and the k^{th} perturbation frequency utilizing the following formulae:

$${\overline{x}}_{- 1 , jk}^{l} = 2 \times {\sum }_{i = 1}^{I / 2} {x}_{- 1 , ijk}^{l} / I \qquad ( 3 )$$

$$and$$

$${\overline{x}}_{1 , jk}^{l} = 2 \times {\sum }_{i = 1}^{I / 2} {x}_{1 , ijk}^{l} / I \qquad ( 4 )$$

$$where {x}_{- 1 , ijk}^{l} ∈ {X}_{- 1}^{l , ( \frac{1}{2} , J , K )} and {x}_{1 , ijk}^{l} ∈ {X}_{1}^{l , ( \frac{I}{2} , J , K )} .$$

The response averages were used to obtain the standard deviation values that were calculated separately within the subgroups that were divided based on the concentration of the l^{th} constituent for each j^{th} index point of the AC voltammogram and the k^{th} sinusoidal perturbation frequency as expressed by following equations:

$${s}_{- 1 , jk}^{l} = \sqrt{\frac{{\sum }_{i = 1}^{I / 2} {( {x}_{- 1 , ijk}^{l} - {\overline{x}}_{- 1 , jk}^{l} )}^{2}}{I / 2 - 1}} \qquad ( 5 )$$

$${s}_{1 , jk}^{l} = \sqrt{\frac{{\sum }_{i = 1}^{I / 2} {( {x}_{1 , ijk}^{l} - {\overline{x}}_{1 , jk}^{l} )}^{2}}{I / 2 - 1}} \qquad ( 6 )$$

for the low and high concentration limits of l^{th} constituent, respectively. The standard deviation values were used to calculate the standard errors individually within each l^{th} constituent concentration based divided subgroup for each j^{th} index point of the AC voltammogram and the k^{th} sinusoidal perturbation frequencies employing the formulae:

$${SE}_{- 1 , jk}^{l} = {s}_{- 1 , jk}^{l} / \sqrt{I / 2} \qquad ( 7 )$$

$${SE}_{1 , jk}^{l} = {s}_{1 , jk}^{l} / \sqrt{I / 2} \qquad ( 8 )$$

for both the low and high concentration limits of the l^{th} constituent, respectively.

The factor effect of low concentration of the l^{th} constituent for the j^{th} index point of the AC voltammogram and the k^{th} frequency was obtained by subtracting from the response average for the low concentration (Equation 3) and the grand average (Equation 2):

$${FE}_{- 1 , jk}^{l} = {\overline{x}}_{- 1 , jk}^{l} - {\overline{x}}_{jk} \qquad ( 9 )$$

The factor effect for the high concentration of the l^{th} constituent for the j^{th} index point of the AC voltammogram and the k^{th} frequency was determined by subtracting from the response average for low concentration (Equation 4) and the grand average (Equation 2):

$${FE}_{1 , jk}^{l} = {\overline{x}}_{1 , jk}^{l} - {\overline{x}}_{jk} \qquad ( 10 )$$

Uniquely for the two-level factorial design and for the same number of samples for the low and the high concentration of the I/2 the factor effect and for the low concentration equals the negative factor effect for high concentration as follows:

$$F {E}_{- 1 , j k}^{l} = - F {E}_{1 , jk}^{l} \qquad ( 11 )$$

The above relationship stems from the fact that:

$${\overline{x}}_{- 1 , j k}^{l} + {\overline{x}}_{1 , jk}^{l} = 2 \times {\overline{x}}_{j k} \qquad ( 12 )$$

The Analysis of Variance (ANOVA) sum of the squares of the low and high concentrations of the l^{th} constituent are defined by the corresponding constituent effects as expressed by Equations 9 and 10, respectively, to obtain:

$$S {S}_{- 1 , j k}^{l} = I / 2 \times {( F {E}_{- 1 , j k}^{l} )}^{2} \qquad ( 13 )$$

$$and$$

$$S {S}_{1 , jk}^{l} = I / 2 \times {( F {E}_{1 , jk}^{l} )}^{2} \qquad ( 14 )$$

respectively. Because of the relationship described by Equation 11, the sum of the squares for the low and high concentrations are equal to each other for two level factorial design and the equal dimensions of the data subarrays corresponding to the low and high concentrations. Therefore, there is no need to distinguish the sum of squares whether or not the sum corresponds to the low or high concentrations:

$$S {S}_{j k}^{l} = S {S}_{- 1 , j k}^{l} + S {S}_{1 , jk}^{l} = 2 \times S {S}_{- 1 , j k}^{l} = 2 \times S {S}_{1 , jk}^{l} \qquad ( 15 )$$

The Analysis of Variance (ANOVA) mean square for the two-level factorial design of equal size of subgroups is defined by subtracting the sum of the squares described in Equation 15 by the number of degrees of freedom for the lth constituent, df^{l}:

$$M {S}_{j k}^{l} = S {S}_{j k}^{l} / {df}^{l} \qquad ( 16 )$$

### The

$$M {S}_{j k}^{l}$$

is an element of the 3-way array of mean squares MS^{(J,K,L)}.

The ANOVA F-ratio is calculated individually for each of the l^{th} constituent of the electroplating bath, each j^{th} index point of the AC voltammogram and each of the k^{th} perturbation frequencies, by dividing the mean square (Equation 16) by the error of variance:

$${F}_{j k}^{l} = \frac{M {S}_{j k}^{l}}{{σ}_{e , jk}^{2}} \qquad ( 17 )$$

An approximate estimate of the error variance,

$${σ}_{e , jk}^{2} ,$$

is determined by pooling the sum of the squares corresponding to the constituents having the lowest mean square. The pooling is conducted within the ANOVA parameters calculated individually for each j^{th} index point of the voltammogram and the k^{th} perturbation frequency. The sum of the squares corresponding to the bottom half of the constituents (as defined by the lower mean square) corresponding to about half of the degrees of freedom, is used to estimate the error mean square or error variance; the number of constituents, J=6, each having the same number of degrees of freedom dfⱼ. The error variance is estimated as:

$${σ}_{e , jk}^{2} = {\sum }_{l = 1}^{L / 2} \frac{{SS}_{jk}^{l}}{{df}^{l}} \qquad ( 18 )$$

Usually, the Analysis of Variance (ANOVA) parameters defined above are reported in a ANOVA table prepared using the input the univariate response vector

$${x}_{j k}^{( I )}$$

and a matrix of factors Y^{(I,L)} (in the example discussed herein, the concentration values). The obtained Mean Square (MS) values of the Analysis of Variance are used to rank the relative importance of each factor, such as the concentrations of the plating solution constituents, with respect to the observed variation in the response. The variation attributable to the least influential constituents as quantified by MS are consolidated. The method pools variation with the data (e.g. multi-frequency voltametric data) from many marginal factors without taking more than half the total degrees of freedom. If the F-ratio nears 1.0 for the constituent, then the effect of that constituent is not distinguishable from the background noise. If the effect of the constituent is not distinguishable from the background noise, the concentration of the constituent cannot be measured from the response, however, there is no upper limit for the F-ratio value. In the example provided herein, the development of a multi-frequency AC voltammetric waveform that exhibits a current response that is predominantly affected by a single constituent concentration of a plating solution constituent, while being negligibly dependent on other factors caused by varying concentrations of the other bath constituents was the goal. To achieve the intended goal, the F-ratio obtained for the j-th factor of interest was significantly greater than F-ratio of the remaining J−1 factors. As the Analysis of Variance (ANOVA) is conducted for each univariate response vector individually,

$${x}_{j k}^{( I )} ,$$

the method is to be executed J×K (where J×K is the total number of univariate response vectors) times to determine the J×K×L F-ratio values. F-ratio values obtained for J×K univariate response cases need to be normalized in order to make the F-ration values comparable with each other for the various j^{th} and k^{th} indexes as the response data in the example provided herein is in a form of a multiway array X^{(I,J,K)}. For example, the predominant F-ratio for the l^{th} constituent for certain values of th and k^{th} indexes was 100, while the predominant ratio calculated for the same constituent for other j^{th} and k^{th} indexes was 10,000. The two exemplary values of F-ratio are quantitatively incomparable with each other, however, their corresponding variables of multivariate voltammetric data are analytically useful provided said corresponding variables of multivariate voltammetric data are analyzed in response to concentration changes of the j-th constituent. To enable comparative analysis of F-ratios calculated for the multivariate voltammetric data, the scaling of the F-ratio resulted in a parameter called the “relative F-ratio” (RF), defined as:

$$R {F}_{j k}^{l} = \frac{{F}_{j k}^{l}}{{\sum }_{l = 1}^{L} {F}_{j k}^{l}} \qquad ( 19 )$$

The values of relative F-ratios are uniformly scaled within the range of [symbol] 0:1 [symbol] for any j^{th} and k^{th} indexes with the F-ratio values corresponding to variables of multivariate voltammetric data of high analytical utility to be closer to 1, wherein the F-ratio values corresponding to variables of multivariate voltammetric data of no analytical utility to be closer to 0.

The substitution of F-ratio in Equation 19 with the value obtained by Equation 17, leads to following equation:

$$R {F}_{j k}^{l} = \frac{M {S}_{j k}^{l} / {σ}_{e , jk}^{2}}{{\sum }_{l = 1}^{L} ( M {s}_{j k}^{l} / {σ}_{e , jk}^{2} )} \qquad ( 20 )$$

that, after simplification, results in the formula for the relative F-ratio:

$$R {F}_{j k}^{l} = \frac{M {S}_{j k}^{l}}{{\sum }_{l = 1}^{L} M {S}_{j k}^{l}} \qquad ( 21 )$$

Based on Equation 21, the relative F-ratio is a relative Mean Square (RMS):

$$R M {S}_{j k}^{l} = R {F}_{j k}^{l} \qquad ( 22 )$$

### Generating a Consolidated Designer Waveform (CDW)

The decisive quantitative parameters for the preliminary waveform assessment determined by the Factor analysis step 9 are relative to the F-ratio (Equation 21) and R² (Equation 1). These two parameters react in unison to indicate the portions of a voltammogram for N waveforms that are useful for further modeling. Any dissonance between the relative F-ratio (Equation 21) and R² (Equation 1) indicates problems with the data, such as the presence of artefacts that may render the data useless. In the acceptance of extracted waveform step 10, analytically useful portions of individual N multifrequency voltammograms are extracted. The useful portions, having a value that is likely to be different from N and greater than or equal to L, are iteratively optimized in the optimizing waveform/extraction of relative portions step 11 starting from the measurements of these selected fragments only taken in the measurement taking step 8 for each of the eight solution composition combinations describe in Table 1. Each solution is analyzed in triplicate. The next step is the Factor analysis step 9 that is executed for the generated multi-frequency voltammetric data for each of the selected fragments of the N initial waveforms individually. The Factor analysis step 9 is executed by implementing Equations 1 to 21.

Provided that the generated waveforms based on the extracted fragments of the preliminary waveforms exhibit a comparable analytical utility to that of the initial waveforms, as quantified by the relative F-ratio (Equation 21) and R² (Equation 1) complementing each other, these fragments of the preliminary waveforms are consolidated to build a designer waveform 12.

The newly created Consolidated Designer Waveform (CDW) is thereafter iteratively optimized by steps 13-16 starting from performing measurements 13 for the eight solution composition combinations of Table 1. Each solution is analyzed in triplicate. The next step is the Factor analysis step 14 performed using the multi-frequency voltammetric data for the CDW following the calculations of Equations 1 to 21. Provided the multi-frequency voltammetric data of the CDW exhibits comparable analytical usefulness as do the individual fragments of multi-frequency voltammetric waveforms taken into consolidation, as quantified by the relative F-ratio (Equation 21) and R² (Equation 1) complement each other, the generated CDW is accepted for building the calibration model.

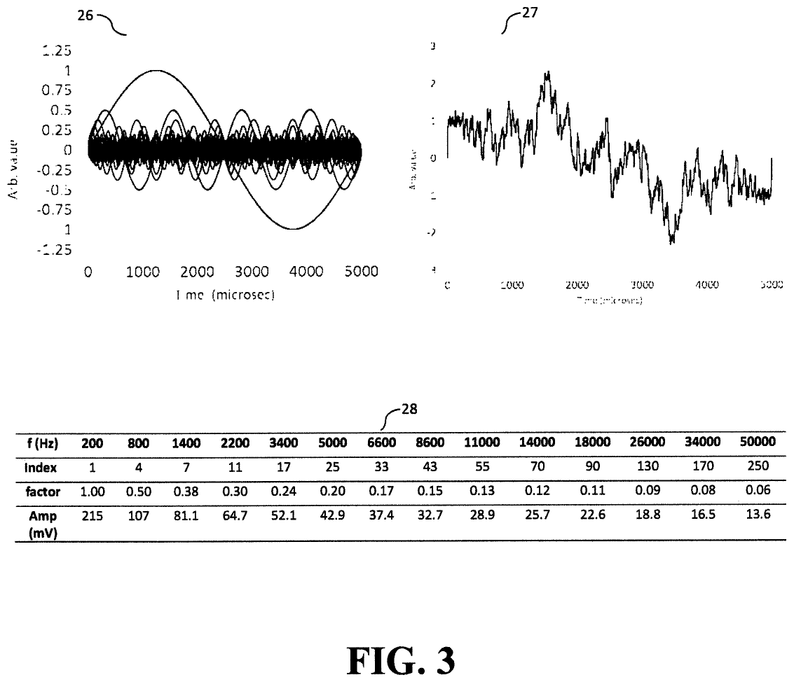

FIG. 3 illustrates a single period of the multi-frequency sinusoidal applied to a potential perturbation 27 consisting of summed fourteen sinewaves 26 of different frequencies and amplitudes 28. The frequencies of the sinewaves range from 40 Hz to 1 MHz, preferably from 40 Hz to 50 Hz. The sum of the amplitudes of the sinewaves for the preferred embodiment, ranges from 5 mV to 1000 mV, preferably in the range of 50 mV to 500 mV. This complex periodical perturbation was superimposed on the consolidated DC potential ramps 29, 30 that correspond to the analytically useful fragments extracted from the initial waveform used in step 7 of FIG. 2.

FIG. 4 illustrates consolidated DC potential ramps. The symmetrical pair of ramps correspond to DC Linear Scan Voltammetry, a single ramp to DC Linear Scan Voltammetry, and a horizontal ramp to Chronoamperometry.

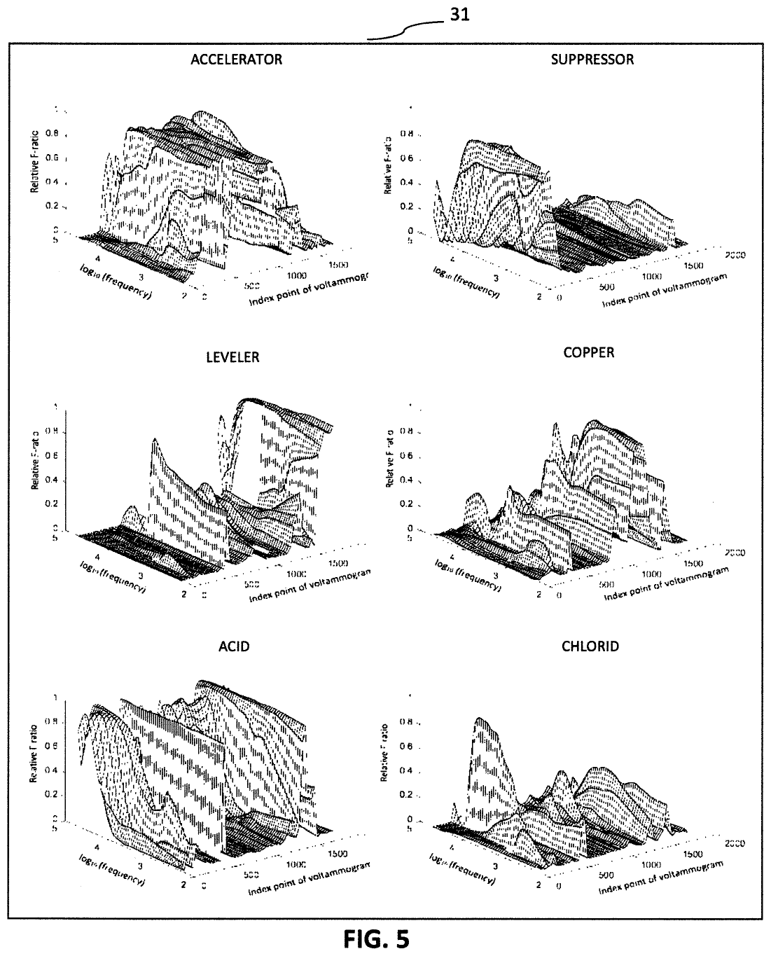

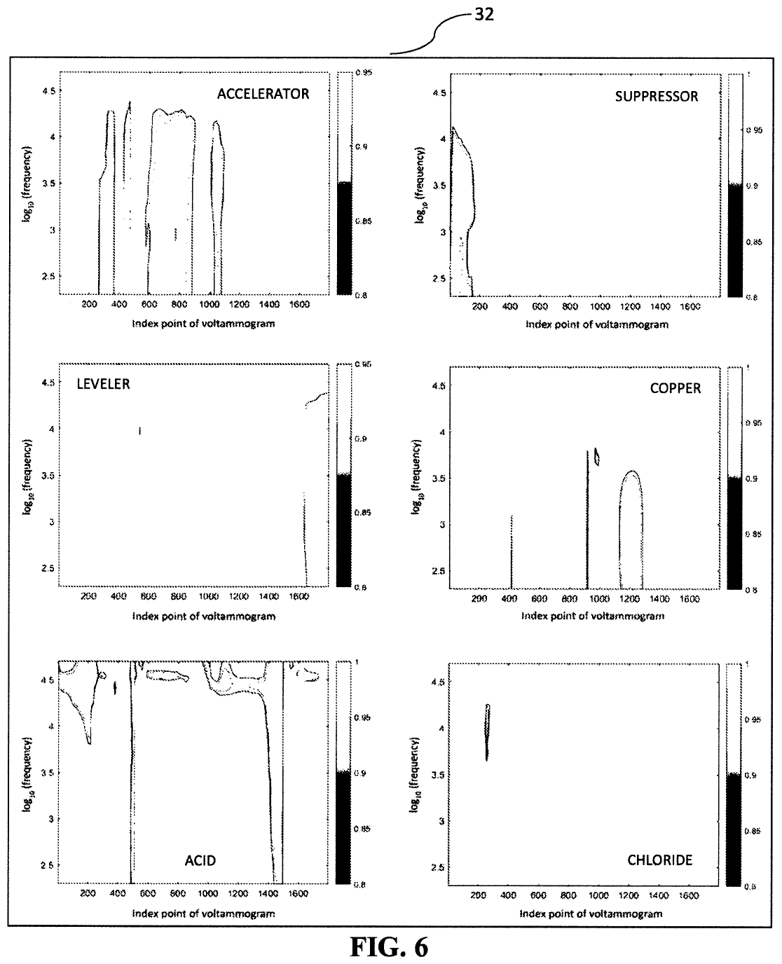

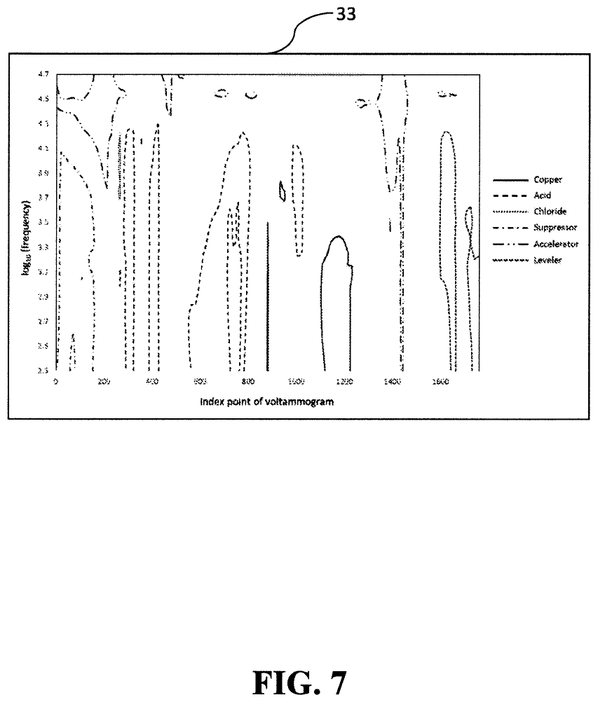

The data collected during the F-factor analysis 31 of FIG. 5 as quantified by the relative F-ratio (Equation 21) for each of the L=6 constituents of the plating bath, is presented in FIG. 5. The same data is presented in a different projection, as contours 32 evidence high analytical utility ranges, individually for each constituent in FIG. 6. The data presented in FIG. 6 is consolidated into a single contour graph 33 from all six bath constituents as presented in FIG. 7. An analytically useful area occupies a significant portion of the contour graph of FIG. 7. The fundamentally novel rigorous steps 7-17 of FIG. 2 allow for the development of a single designer voltammogram, CDW, capable of measuring simultaneously the concentrations of the six distinct constituent chemical species both qualitatively and quantitatively. As an additional challenge, the distinct chemical species are intended to interact with each other synergistically during the monitored plating process. The concentrations of the plating bath constituents are determined in an unaltered solution sample by an electrochemical method, such as Complex Designer Voltammetry (CDV) utilizing experimental conditions mirroring those of the chosen plating process resulting in high analytical and process control relevance. The application of multi-sinusoidal potential perturbation 23 on DC ramps 29, 30 allows to achieve experimental conditions requirements needed for analyses of all deliberately added bath constituents. The application of multi-sinusoidal potential perturbation 23 on DC ramps 29, 30 allows analyses of all deliberately added bath constituents with a single Consolidated Designer Waveform. The application of multi-sinusoidal potential perturbation 23 on DC ramps 29, 30 allows simultaneous analyses of constituents of fundamentally different properties, such as chemical structure, concentration, electrochemical reactivity with a single Consolidated Designer Waveform. The application of multi-sinusoidal potential perturbation 23 on DC ramps 29, 30 does not compromise the experimental time as compared to the DC ramp. Multi-frequency potential perturbations upgrade a conventional electroanalytical first-order instrument to a second-order instrument without additional experimental time.

### Building a Calibration Model

Once the CDW is accepted in step 17 of FIG. 2, the CDW is used to collect master calibration voltammetric data. This data is subjected to a routine calibration calculation as discussed in U.S. Pat. No. 7,270,733 (WIKIEL et al., 2007).

We claim:

1. A device designed to monitor the concentrations of the constituents of a plating bath during an electrometallization process, the device comprising:
(a) a personal computer;
(b) a real time electrochemical analyzer comprising
(1) a comprehensive electrochemical controller
(I) a potentiostat;
(II) a consolidated designer waveform generator designed to create a consolidated designer waveform comprised of segments having both AC and DC components; and
(III) a data acquisition module; and
(2) an electrochemical probe comprising
(I) an electrochemical sensor comprising an inner compartment; and
(II) a pump; and
(c) a plating bath comprised of constituents that fill the inner compartment of the multi-task electrochemical probe;
wherein the real time electrochemical analyzer analyzes the plating bath constituents using an electroanalysis process is Alternating Current Voltammetry (ACV).

2. The device according to claim 1, wherein the consolidated designer waveform from the comprehensive electrochemical controller is applied to the electrochemical sensor.

3. The device according to claim 1, wherein the segments of the consolidated designer waveform are designer AC waveforms are comprised of a sum of multiple sinewaves having different frequencies and amplitudes.

4. The device according to claim 3, wherein the frequencies of the sinewaves range from 40 Hz to 1 MHz.

5. The device according to claim 4, wherein the frequencies of the sinewaves range from 40 Hz to 50 kHz.

6. The device according to claim 3, wherein the sum of the amplitudes of the sinewaves ranges from 5 mV to 1,000 mV.

7. The device according to claim 1, wherein the DC component of each segment of the consolidated designer waveform ranges from +3V to −3V.

8. The device according to claim 1, wherein the DC component of each segment of the consolidated designer waveform exhibits scan rates ranging from 5 mV/s to 20,000 mV/s.

9. The device according to claim 1, wherein as the consolidated designer waveform is generated, the segments of the consolidated designer waveform are selected using an Analysis of Variance relative F-ratio.

10. The device according to claim 9, wherein the selected segments of the consolidated designer waveforms have a relative F-ratio for each bath constituent higher than 0.8.

11. The device according to claim 9, wherein the selected segments of the consolidated designer waveforms have a relative F-ratio for each bath constituent higher than 0.9.

12. The device according to claim 1, wherein the plating bath is an electroplating bath.

13. The device according to claim 12, wherein the electroplating bath comprises one or more of the metals selected from the group consisting of Cu, Sn, Pb, Ni, Zn, Ag, Au, Cd, Co, Cr, Rh, Ru, Pd, In, Bi, and their alloys.

14. The device according to claim 1, wherein the segments of the consolidated designer waveform are the sum of AC and DC components.

15. The device according to claim 14, wherein a single consolidated designer waveform consists of segments whose current output responds to all of the electroplating bath constituents.

16. The device according to claim 15, wherein DC component of a segment of the consolidated designer waveform comprises of DC Cyclic Voltammetry, DC Linear Scan Voltammetry and/or Chronoamperometry techniques.

17. The device designed to monitor the concentrations of the constituents of a plating bath during an electrometallization process according to claim 1, wherein the electrochemical sensor is a compact, flow-through electrochemical cell.

18. The device designed to monitor the concentrations of the constituents of a plating bath during an electrometallization process according to claim 1, wherein the inner compartment of the electrochemical probe contains up to 20 ml of the plating bath.

19. The device designed to monitor the concentrations of the constituents of a plating bath during an electrometallization process according to claim 1, wherein the comprehensive electrochemical controller generates Dynamic Electrochemical Impedance spectrums, or Fourier Transform Alternating Current (FT-AC) Multi-frequency Voltammograms.
